(19) United States
(12) Patent Application Publication
(10) Pub. No.: US 2025/0139585 A1
(43) Pub. Date: May 1, 2025

(54) METHODS AND DEVICES TO MANAGE SHARING OF CONTACT INFORMATION

(71) Applicant: MOTOROLA MOBILITY LLC, WILMINGTON, DE (US)

(72) Inventors: AMIT KUMAR AGRAWAL, BANGALORE (IN); KRISHNAN RAGHAVAN, BANGALORE (IN); HARIPRASAD SHANBHOGUE ALAMPADY, BANGALORE (IN)

(21) Appl. No.: 18/496,883

(22) Filed: Oct. 29, 2023

(51) Int. Cl. G06Q 10/107

(52) U.S. Cl. CPC G06Q 10/107

(57) ABSTRACT

An electronic device, computer program product, and method are provided that present or share contact details of a contact. At least one processor executes code to (i) identify, for a first contact maintained within a contact directory utilized by the electronic device, first contact details that is publicly sharable; (ii) identify, for the first contact, second contact details that comprises information that is contextually limited from being publicly shared or presented; and (iii) in response to detecting an operation to share or present the first contact, selectively share or present only the first contact details and withhold sharing or presenting of the second contact details.

### BACKGROUND

### 1. Technical Field

The present disclosure relates generally to electronic devices that manage electronic contacts and in particular to electronic devices that support presenting or sharing contact details.

### 2. Description of the Related Art

Electronic devices, such as cell phones, tablets, and laptops, are widely used for presenting information and for communication and data transmission. These electronic devices support various communication modes/applications, such as text messaging, audio calling and video calling. Most communications between two electronic devices involve a first user of an electronic device initiating a communication with a second user of another electronic device. In normal operations, information about the second user is stored as contact data in a contact directory and is accessible by the electronic device of the first user. Typically, the information about the second user includes the name and telephone number of the second user. In certain situations, the information about the second user may include information that is private to the first user.

### BRIEF DESCRIPTION OF THE DRAWINGS

The description of the illustrative embodiments can be read in conjunction with the accompanying figures. It will be appreciated that for simplicity and clarity of illustration, elements illustrated in the figures have not necessarily been drawn to scale. For example, the dimensions of some of the elements are exaggerated relative to other elements. Embodiments incorporating teachings of the present disclosure are shown and described with respect to the figures presented herein, in which:

FIG. 1 depicts an example electronic device within which various aspects of the disclosure can be implemented, according to one or more embodiments.

FIGS. 2A-2B depict a contact directory and example contact details presented within a display of an electronic device which can be used by a first user to view contact information of different contacts in the contact directory, according to one or more embodiments.

FIGS. 3A-3B depict an example scenario where an electronic device of a first user receives a telephone call from an electronic device of a second user whose contact information is included, with an assigned personal name, in a contact directory of the electronic device of the first user, according to one or more embodiments.

FIGS. 3C-3D depict an example scenario where the electronic device of the first user of FIG. 3A receives a telephone call from the electronic device of the second user of FIG. 3A in a different context or setting that is non-private, according to one or more embodiments.

FIG. 4A depicts a sharing window by which contact details of a contact associated with a first electronic device is shared with a user of a second electronic device, according to one or more embodiments.

FIG. 4B-4C depict two different types of contact details that are respectively transmitted during the sharing of the contact with the second electronic device in FIG. 4A, based on a status of the user/identifier associated with the second electronic device, according to one or more embodiments.

FIGS. 4D-4E depict a sharing environment where a set of contact information, including personal contact details, of a contact associated with one electronic device is selectively obscured when shared as a screen shot with another electronic device, according to one or more embodiments.

FIG. 4F depicts the automatic obscuring of specific portions of contact information, including personal contact details, when opening and/or presenting a contact on a display of the electronic device while in a public setting, according to one or more embodiments.

FIG. 5A depicts a flow diagram of a process that can be used to share or present first contact details or second contact details based on detecting an operation to share or to present and based on a context or settings associated with the operation to share or present, in one or more embodiments.

FIG. 5B depicts a flow diagram of a process that can be used to determine a status of a user for the purpose of sharing contact details of a contact, in one or more embodiments.

FIG. 6 depicts a flow diagram of a process that can be used to generate formal contact identifier and a set of formal contact information to be shared or presented by the electronic device when the recipient is not a trusted associate, in one or more embodiments

FIG. 7 depicts a flow diagram of a process that can be used to generate the formal contact identifier and the set of formal contact information for a contact based on information included in the contact directory and secondary sources, in one or more embodiments.

FIG. 8 depicts a flow diagram of a process that can be used to enable sharing a screenshot of contact details with a second electronic device when the user of the second electronic device is not a trusted associate, in one or more embodiments.

### DETAILED DESCRIPTION

The present disclosure provides an electronic device, a method, and a computer program product that enables selective presenting and/or sharing of contact details from contacts included in a contact directory of an electronic device. In one or more embodiments, the electronic device includes a memory having stored thereon a contact management and sharing module for managing contact sharing. The electronic device also includes at least one processor communicatively coupled to the memory. The at least one processor executes program code of the contact management and sharing module to cause the processor to (i) identify, for a first contact maintained within a contact directory utilized by the electronic device, first contact details that are publicly sharable; (ii) identify, for the first contact, second contact details that includes information that is contextually limited from being publicly shared or presented; and (iii) in response to the processor detecting an operation to share or present the first contact, selectively share or present only the first contact details and withhold sharing or presenting of the second contact details.

In one or more embodiments, the method provides computer-implemented processes for identifying and autonomously modifying the presenting or sharing of contact information. The method includes identifying, for a first contact maintained within a contact directory utilized by an electronic device, first contact details that is publicly sharable. The method includes identifying, for the first contact, second contact details that comprises information that is contextually limited from being publicly shared or presented. The method includes, in response to detecting an operation to share or present the first contact, selectively sharing or presenting only the first contact details and withhold sharing or presenting of the second contact details.

In one or more embodiments, the disclosure may include a computer program product that includes a computer readable storage device and program code on the computer readable storage device that when executed by a processor associated with an electronic device, the program code enables the communication device to provide functionality of the above-described method processes.

In the following detailed description of exemplary embodiments of the disclosure, specific exemplary embodiments in which the various aspects of the disclosure may be practiced are described in sufficient detail to enable those skilled in the art to practice the invention, and it is to be understood that other embodiments may be utilized and that logical, architectural, programmatic, mechanical, electrical, and other changes may be made without departing from the spirit or scope of the present disclosure. The following detailed description is, therefore, not to be taken in a limiting sense, and the scope of the present disclosure is defined by the appended claims and equivalents thereof. Within the descriptions of the different views of the figures, similar elements are provided similar names and reference numerals as those of the previous figure(s). The specific numerals assigned to the elements are provided solely to aid in the description and are not meant to imply any limitations (structural or functional or otherwise) on the described embodiment. It will be appreciated that for simplicity and clarity of illustration, elements illustrated in the figures have not necessarily been drawn to scale. For example, the dimensions of some of the elements are exaggerated relative to other elements.

It is understood that the use of specific component, device and/or parameter names, such as those of the executing utility, logic, and/or firmware described herein, are for example only and not meant to imply any limitations on the described embodiments. The embodiments may thus be described with different nomenclature and/or terminology utilized to describe the components, devices, parameters, methods and/or functions herein, without limitation. References to any specific protocol or proprietary name in describing one or more elements, features or concepts of the embodiments are provided solely as examples of one implementation, and such references do not limit the extension of the claimed embodiments to embodiments in which different element, feature, protocol, or concept names are utilized. Thus, each term utilized herein is to be given its broadest interpretation given the context in which that term is utilized.

As further described below, implementation of the functional features of the disclosure described herein is provided within processing devices and/or structures and can involve use of a combination of hardware, firmware, as well as several software-level constructs (e.g., program code and/or program instructions and/or pseudo-code) that execute to provide a specific utility for the device or a specific functional logic. The presented figures illustrate both hardware components and software and/or logic components.

Those of ordinary skill in the art will appreciate that the hardware components and basic configurations depicted in the figures may vary. The illustrative components are not intended to be exhaustive, but rather are representative to highlight essential components that are utilized to implement aspects of the described embodiments. For example, other devices/components may be used in addition to or in place of the hardware and/or firmware depicted. The depicted example is not meant to imply architectural or other limitations with respect to the presently described embodiments and/or the general invention. The description of the illustrative embodiments can be read in conjunction with the accompanying figures. Embodiments incorporating teachings of the present disclosure are shown and described with respect to the figures presented herein.

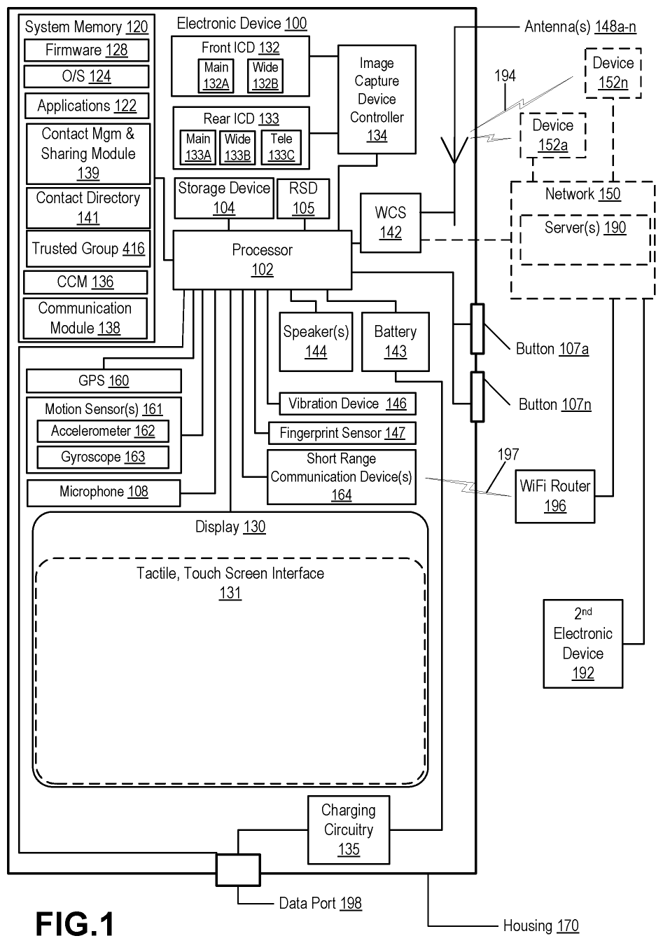

FIG. 1 depicts an example electronic device 100 within which various aspects of the disclosure can be implemented, according to one or more embodiments. Examples of such electronic devices include, but are not limited to, mobile devices, a notebook computer, a mobile phone, a digital camera, a smart watch, a tablet computer and a communication device, etc. Electronic device 100 includes processor 102, which is communicatively coupled to storage device 104, system memory 120, input devices, introduced below, output devices, such as display 130, and image capture device (ICD) controller 134. Processor 102 can include processor resources such as a central processing unit (CPU) that support computing, classifying, processing, and transmitting of data and information. The ICD controller 134 may perform or support functions such as, but not limited to, selecting and activating an active camera from among multiple cameras. Throughout the disclosure, the term image capturing device is utilized interchangeably to be synonymous with and/or refer to any one of front or rear facing cameras 132, 133.

System memory 120 may be a combination of volatile and non-volatile memory, such as random-access memory (RAM) and read-only memory (ROM). System memory 120 can store program code or similar data associated with firmware 128, an operating system 124, applications 122, camera control module (CCM) 136, contact management and sharing module 139, and communication module 138. Communication module 138 includes program code that is executed by processor 102 to enable electronic device 100 to communicate with other external devices and systems.

Although depicted as being separate from applications 122, CCM 136 and communication module 138 may be each implemented as an application. Processor 102 loads and executes program code stored in system memory 120. Examples of program code that may be loaded and executed by processor 102 include program code associated with applications 122 and program code associated with CCM 136, contact management and sharing module 139, and communication module 138. Execution of the code associated with the contact management and sharing module 139 causes the processor to access the contact directory 141 which is used to store contact information of different contacts including, for example, family members, personal acquaintances, and non-personal acquaintances.

In one or more embodiments, electronic device includes removable storage device (RSD) 105, which is inserted into an RSD interface (not shown) that is communicatively coupled via system interlink to processor 102. In one or more embodiments, RSD 105 is a non-transitory computer program product or computer readable storage device. RSD 105 may have a version of CCM 136 stored thereon, in addition to other program code. Processor 102 can access RSD 105 to provision electronic device 100 with program code that, when executed by processor 102, the program code causes or configures electronic device 100 to provide the functionality described herein.

Display 130 can be one of a wide variety of display screens or devices, such as a liquid crystal display (LCD) and an organic light emitting diode (OLED) display. In some embodiments, display 130 can be a touch screen device that can receive user tactile/touch input. As a touch screen device, display 130 includes a tactile, touch screen interface 131 that allows a user to provide input to or to control electronic device 100 by touching features presented within/below the display screen. Tactile, touch screen interface 131 can be utilized as an input device.

Front facing cameras (or image capture device (ICD)) 132 are communicatively coupled to ICD controller 134, which is communicatively coupled to processor 102. ICD controller 134 supports the processing of signals from front facing cameras 132. Front facing cameras 132 can capture images that are within the field of view (FOV) of image capture device 132. Electronic device 100 includes several front facing cameras 132. First front facing camera 132A is a main camera that captures a standard angle FOV. Second front facing camera 132B is wide angle camera that captures a wide angle FOV. Front facing cameras 132A and 132B can be collectively referred to as front facing cameras 132A-132B or front facing camera(s) 132. While two front facing cameras 132A-132B are shown, electronic device 100 can have more or less than two front facing cameras.

Electronic device 100 further includes several rear facing cameras 133. First rear facing camera 133A is a main camera that captures a standard angle FOV. Second rear facing camera 133B is wide angle camera that captures a wide angle FOV. Third rear facing camera 133C is a telephoto ICD that captures a telephoto FOV (zoom or magnified). Each rear facing camera 133A, 133B, and 133C is communicatively coupled to ICD controller 134, which is communicatively coupled to processor 102. ICD controller 134 supports the processing of signals from rear facing cameras 133A, 133B and 133C. Rear facing cameras 133A, 133B and 133C can be collectively referred to as rear facing cameras 133A-133C or rear facing cameras 133. While three rear facing cameras are shown, electronic device 100 can have less than three rear facing cameras, such as having only one or two rear facing cameras, or can have more than three rear facing cameras.

Electronic device 100 can further include data port 198, charging circuitry 135, and battery 143. Electronic device 100 further includes microphone 108, one or more output devices such as speakers 144, and one or more input buttons 107a-n. Input buttons 107a-n may provide controls for volume, power, and image capture device 132. Microphone 108 can also be referred to as audio input device 108. Microphone 108 and input buttons 107a-n can also be referred to generally as input devices.

Electronic device 100 further includes wireless communication subsystem (WCS) 142, which is coupled to antennas 148a-n. In one or more embodiments, WCS 142 can include a communication module with one or more baseband processors or digital signal processors, one or more modems, and a radio frequency (RF) front end having one or more transmitters and one or more receivers. Wireless communication subsystem (WCS) 142 and antennas 148a-n allow electronic device 100 to communicate wirelessly with wireless network 150 via transmissions of communication signals 194 to and from network communication devices 152a-n, such as base stations or cellular nodes, of wireless network 150. In one embodiment, network communication devices 152a-n contain electronic communication equipment to allow communication with electronic device 100.

Wireless network 150 further allows electronic device 100 to wirelessly communicate with second electronic devices 192, which can be similarly connected to wireless network 150 via one of network communication devices 152a-n. Wireless network 150 is communicatively coupled to wireless fidelity (WiFi) router 196. Electronic device 100 can also communicate wirelessly with wireless network 150 via communication signals 197 transmitted by short range communication device(s) 164 to and from WiFi router 196, which is communicatively connected to network 150. In one or more embodiment, wireless network 150 can include one or more servers 190 that support exchange of wireless data and video and other communication between electronic device 100 and second electronic device 192.

Electronic device 100 further includes short range communication device(s) 164. Short range communication device 164 is a low powered transceiver that can wirelessly communicate with other devices. Short range communication device 164 can include one or more of a variety of devices, such as a near field communication (NFC) device, a Bluetooth device, and/or a wireless fidelity (Wi-Fi) device. Short range communication device 164 can wirelessly communicate with WiFi router 196 via communication signals 197. In one embodiment, electronic device 100 can receive internet or Wi-Fi based calls via short range communication device 164. In one embodiment, electronic device 100 can communicate with WiFi router 196 wirelessly via short range communication device 164. In an embodiment, WCS 142, antennas 148a-n and short-range communication device(s) 164 collectively provide communication interface(s) of electronic device 100. These communication interfaces enable electronic device 100 to communicatively connect to at least one second electronic device 192 via at least one network.

Electronic device 100 further includes vibration device 146, fingerprint sensor 147, global positioning system (GPS) device 160, and motion sensor(s) 161. Vibration device 146 can cause electronic device 100 to vibrate or shake when activated. Vibration device 146 can be activated during an in-coming call or message in order to provide an alert or notification to a user of electronic device 100. According to one aspect of the disclosure, display 130, speakers 144, and vibration device 146 can generally and collectively be referred to as output devices.

Fingerprint sensor 147 can be used to provide biometric data to identify or authenticate a user. GPS device 160 can provide time data and location data about the physical location of electronic device 100 using geospatial input received from GPS satellites.

Motion sensor(s) 161 can include one or more accelerometers 162 and gyroscope 163. Motion sensor(s) 161 can detect movement of electronic device 100 and provide motion data to processor 102 indicating the spatial orientation and movement of electronic device 100. Accelerometers 162 measure linear acceleration of movement of electronic device 100 in multiple axes (X, Y and Z). For example, accelerometers 162 can include three accelerometers, where one accelerometer measures linear acceleration in the X axis, one accelerometer measures linear acceleration in the Y axis, and one accelerometer measures linear acceleration in the Z axis. Gyroscope 163 measures rotation or angular rotational velocity of electronic device 100. In one or more embodiments, the measurements of these various sensors can also be utilized by processor 102 in the determining of the context of a communication. Electronic device 100 further includes housing 170 that contains/protects the components of electronic device 100.

In the description of each of the following figures, reference is also made to specific components illustrated within the preceding figure(s). Similar components are presented with the same reference number and some components may be provided with a subscripted reference number (e.g., 100a, 100b) to represent a same component/device being shown in a different context/configuration.

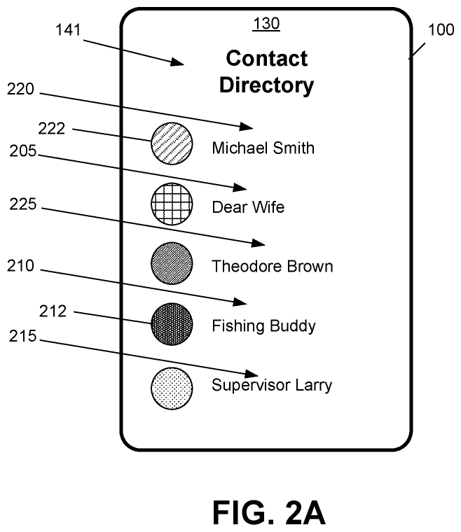

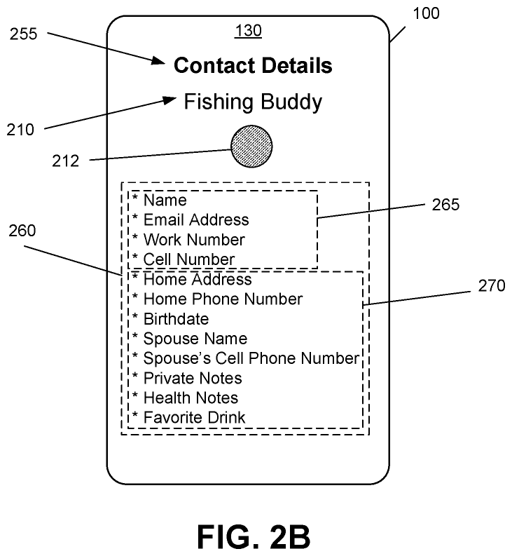

FIGS. 2A-2B depict a contact directory 141 and contact details presented within an example display of an electronic device which can be used by a first user to view contact information of different contacts in the contact directory 141, according to one or more embodiments. Referring to FIG. 2A, electronic device 100 may include display 130. A user of the electronic device 100 may store contact information about family members, personal acquaintances, and non-personal acquaintances in a contact directory 141. The contact directory 141 may be stored in one or more of the memory 120 of the electronic device 100 and a cloud storage (not shown) connected via the network 150.

As an example, the contact directory 141 includes one family members contact 205, three non-personal acquaintance contacts 215-225 and one personal acquaintance contact 210. As depicted in FIG. 2A, each contact 205-225 may be assigned a contact identifier. For example, the contact identifier assigned to the family member contact 205 is “Dear Wife,” the contact identifier assigned to a personal acquaintance contact 210 is “Fishing Buddy,” and the contact identifier assigned to a non-personal acquaintance contact 220 is “Michael Smith.” In one or more embodiments, a contact identifier may be assigned by a user of the electronic device 100. For some alternative embodiments, a contact identifier may be autonomously generated by the electronic device 100. In one or more embodiments, a contact icon may be associated with the contact. For example, a contact icon may be an image of the person associated with the contact, a capital letter, or an image of an object. As depicted in FIG. 2A, contact icon 222 is associated with contact identifier 220, and contact icon 212 is associated with contact identifier 210. While only a set number of contacts are shown in the example contact directory 141, it is appreciated that the contact directory 141 can include any number of contacts from one (1) contact up to a larger number of contacts, limited by the storage limit for contacts within the contact database of the device. Also, the presentation order of the contacts can be alphabetical, based on the contact identifier, to facilitate searching the contact database. Additional contacts can be displayed by scrolling up or down through the list of contacts.

FIG. 2B depicts example contact details 255 of a contact presented on the display 103 of the electronic device 100, in one or more embodiments. Contact details 255 may include a contact identifier 210 and contact information 260. The contact information 260 may include personal attributes and profile data associated with the person corresponding to the contact. According to one aspect of the described embodiments, the contact information 260 may include a set of formal contact information 265 and a set of informal contact information 270. For one or more embodiments, the set of formal contact information may be presented or shared by the electronic device 100 in settings that may not be considered to be private. In one or more embodiments, the set of informal contact information 270 may include information that is more personal than the information included in the set of formal contact information 265.

In one or more embodiments, a formal contact identifier may be associated with the set of formal contact information 265, and an informal contact identifier may be associated with the set of informal contact information 270. In one or more embodiments, the informal contact identifier may also include personal information. It may also be noted that, although the set of formal contact information 265 and the set of informal contact information 270 are presented in an order as distinct sets, it may be possible that the entries in each set may be presented or stored in any order. For example, the email address entry of the set of formal contact information 265 may be presented on the display 103 immediately below the birthdate entry of the set of informal contact information 270. In the example depicted in FIG. 2A, it may be possible that the contact information associated with family members and personal acquaintances are considered as sets of informal contact information.

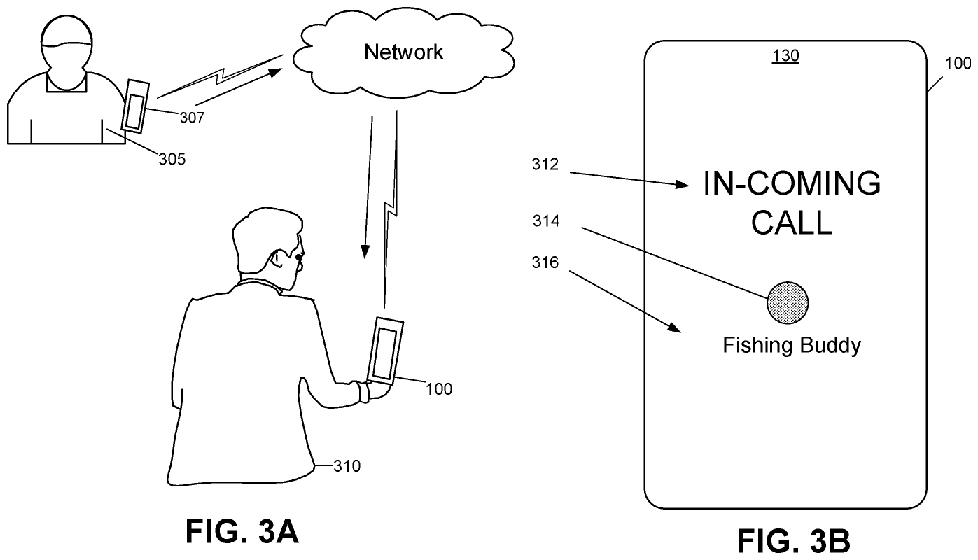

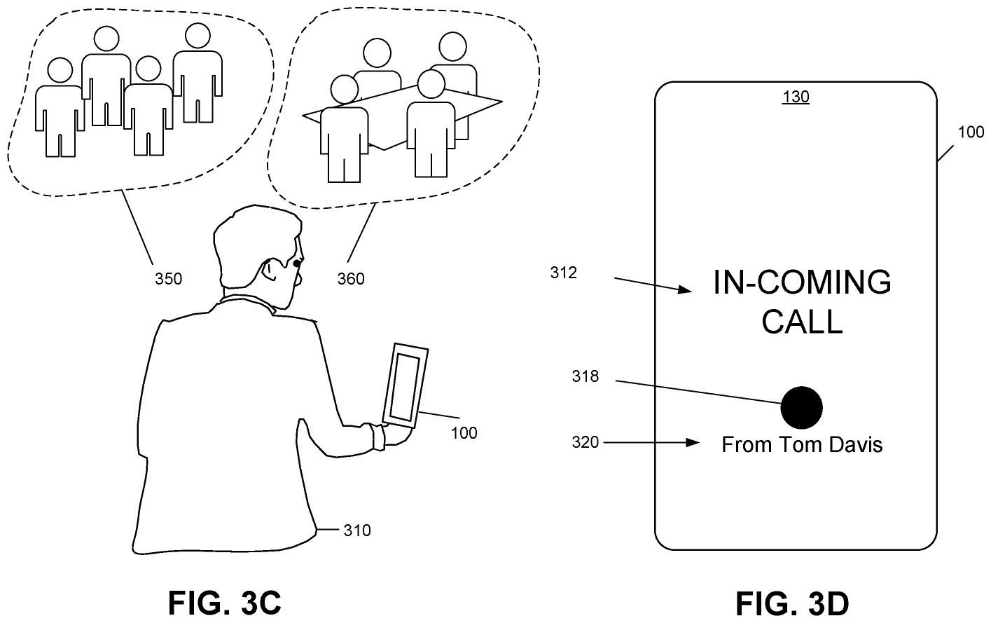

FIGS. 3A-3B depict an example scenario where an electronic device 100 of a first user 310 receives a telephone call from an electronic device 307 of a second user 305 whose contact information is included, with an assigned personal name, in a contact directory 141 of the electronic device 100 of the first user 310, according to one or more embodiments. In the presented example, the second user 305 is a personal acquaintance of the first user 310, and the first user 310 may include personal information in the contact details associated with the second user 305. In normal operations, when the electronic device 100 receives the telephone call from the electronic device 307, as depicted in FIG. 3A, an in-coming call notification 312 is presented within the display 130. The contact identifier 316 and the contact icon 314 associated with the in-coming call notification 312 may also be presented, as depicted in FIG. 3B. In FIG. 3B, the in-coming call notification 312 identifies the calling party (i.e., the second user) with the personalized nickname ‘Fishing Buddy’ that is assigned to the second user within the contact list of the first user's electronic device 100. In one or more embodiments, when the first user is in a private setting, the personalized nickname is presented and can also be accompanied by a personalized icon, different from the formal icon assigned with the set of formal contact information.

In some situations, when the in-coming call is from a family member or a personal acquaintance, the user 310 may prefer to keep private the personalized identifying information presented with the in-coming call notification 312. FIGS. 3C-3D depict an example scenario where the electronic device 100 of the first user 310 of FIG. 3A receives a telephone call from the electronic device 100 of the second user 310 of FIG. 3A in a different context or setting that is non-private, according to one or more embodiments. As utilized within the descriptions, a public environment is a location at which other people, other than the user 310, may be able to see the contact information being presented on the device display. Referring to FIG. 3C, when the user 310 is using the electronic device 100 in a setting where there are lots of other people present, the user 310 may prefer to keep private certain personal information associated with a contact within the contact directory 141. This contact information may include personal information associated with family members and personal acquaintances. Examples of the setting where the user 310 may desire/prefer to keep personal information private includes a public context/setting 350 (e.g., on a train, at the airport, or in a restaurant) and a workplace context/setting 360.

In one or more embodiments, when the processor 102 of the electronic device 100 detects an in-coming telephone call, the processor 102 may identify a current context or setting before presenting, within the display 130, any contact details about the contact associated with the in-coming call. For example, the processor 102 may identify a current context or setting using a global positioning system (GPS) (not shown) and/or a map system (not shown). When the context or setting is identified, the processor 102 may determine whether the context or setting requires presenting only a formal contact identifier (i.e., not presenting the personal contact identifier). As depicted in FIG. 3D, when the setting is identified as either the public setting or the workplace setting, the formal contact identifier “Tom Davis” is presented instead of the informal contact identifier “Fishing Buddy”. For one or more embodiments, the contact icon 314, as depicted in FIG. 3A, may be replaced with a different contact icon 318, as depicted in FIG. 3D. For example, instead of presenting the contact icon 314 depicting an image of Tom holding a fish, an updated contact icon 318 depicting a blue sky or Tom in formal attire may be presented. In one or more embodiments, when the context or setting is determined to be a private context or setting (e.g., being in a private space versus being in a public space and being at home versus being in the office), the contact management and sharing module 139 can include code to enable the processor 102 to present the informal contact identifier within the display 130.

In one or more embodiments, the contact management and sharing module 139 may include code to enable the processors 102 to present the user 310 of the electronic device 100 with an option to manually specify a setting for sharing contact details. The processor 102 may then use the setting to determine whether to present the set of formal or informal contact information. In one or more embodiments, the contact directory 141 may include information that enables the processor 102 to distinguish the set of formal contact information from the set of informal contact information. Alternatively, the contact management and sharing module 139 may include code to enable the processor 102 to evaluate the context of a set of contact information to determine whether the information is a set of formal contact information or a set of informal contact information.

In one or more embodiments, when the processor 102 determines that the contact directory 141 includes only a set of informal contact information for a contact, the processor 102 may perform operations to extract information from the set of informal contact information to generate a corresponding set of formal contact information. Similarly, operations may be performed by the processor 102 to generate a formal contact identifier using the information extracted from the set of informal contact information. In one or more embodiments, in addition to or instead of using the set of informal contact information, one or more secondary sources of information may be accessed by the processor 102 to extract information to generate the set of formal contact information. For example, the one or more secondary sources of information may include records of prior communication between the user 310 and the user 305, such as text messages, emails, etc.

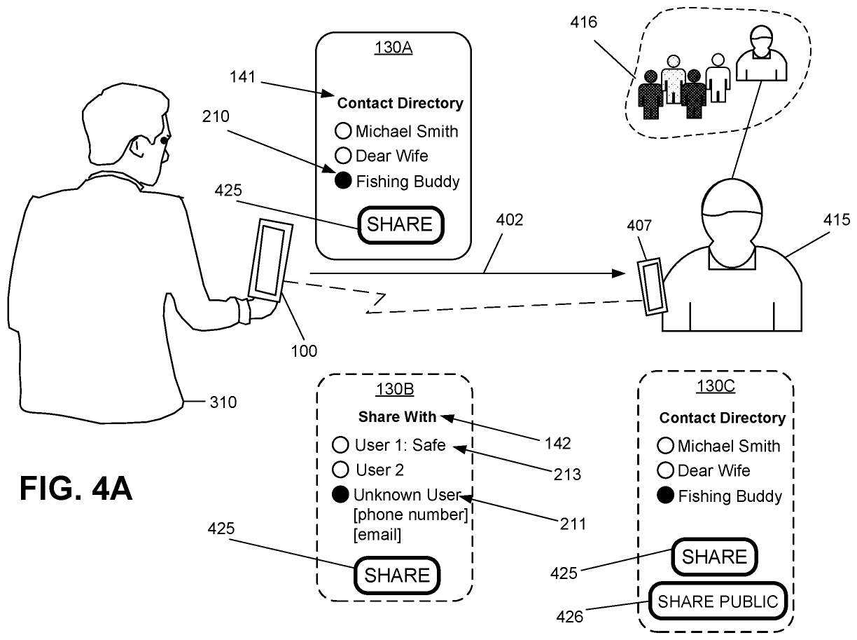

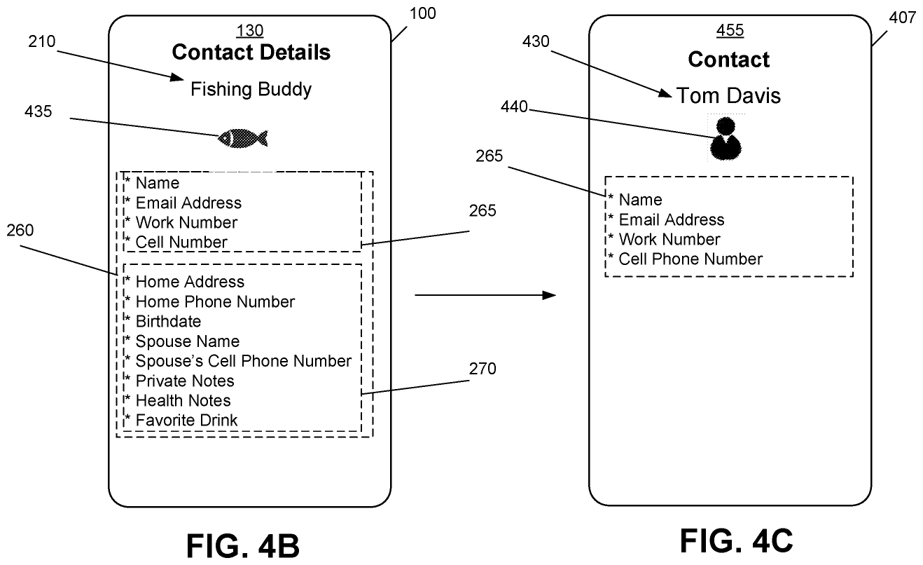

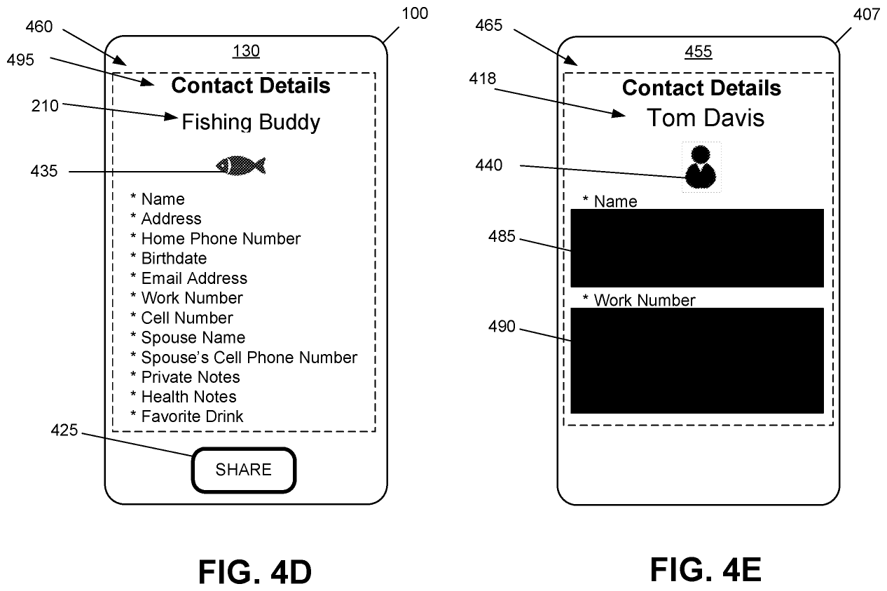

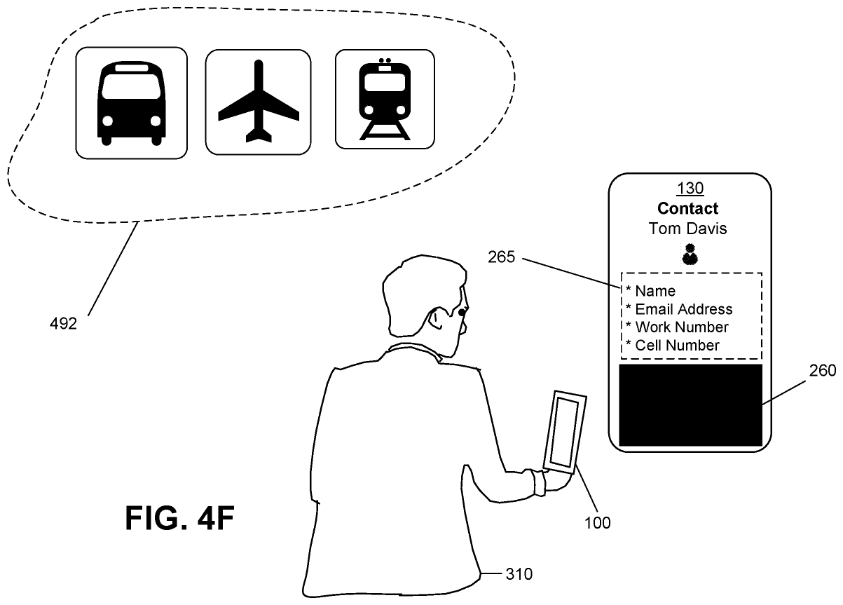

FIG. 4A depicts a contact sharing window by which contact details 255 of a contact associated with a first electronic device 100 is shared by a first user 310 with a second user 415 of a second electronic device 407, in one or more embodiments. Directional line 402 is used to depict the sharing is from the first user 310 to the second user 415. As described above, a contact detail of a contact may include a contact identifier and contact information (FIG. 2A). The contact management and sharing module 139 may include code to enable the processor 102 to present the first user 310 of the electronic device 100 with a share option 425. The first user 310 may select a contact identifier on the display 130A of the electronic device 100. The example in FIG. 4A shows three contact identifiers, each associated with a radio button, presented within the display 130A. The radio button associated with the contact identifier “Fishing Buddy” 210 is shown as having been selected. The first user 310 may then select the share option 425 to share the contact information associated with the selected contact identifier “Fishing Buddy” 210 included in the contact directory 141. FIG. 4A also depicts a safe or trusted group 416 of which the members include only those with whom the user 100 is comfortable sharing both the sets of formal and informal contact information. For example, the second user 415 is depicted to be a member of the safe or trusted group 416.

In one or more embodiments, after presenting the contact directory 141 and the share option 425 within the display 130A, the contact management and sharing module 139 presents the share option 425 within a “Share With” window or user interface (UI) 130B, which lists or presents options for selecting from among different recipients to receive the contact details of a contact. The first user 305 of the first electronic device 100 can then input or select a recipient (or second user) to share contact details of a contact with. In one or more embodiments, a recipient in the “Share With” UI 130B can be flagged as a safe or trusted associate. For example, “User 1” 213 is listed within the UI 130B as “safe.” In one or more embodiments, the “Share With” UI 130B can include an “unknown user” entry 211, which indicates that the recipient is not included in the contact directory 141 of the first electronic device 100. In the situation of an unknown recipient, other information related to the “unknown user” entry 211 can be used including, for example, a telephone number, an email address, etc. An example of an unknown user would be a person that the first user 310 just met but with whom the first user 310 wants to share the contact details of a contact as a referral to the unknown user.

In one or more embodiments, the share option 425 can be used to share both the set of formal contact information and the set of informal contact information of a contact. In one or more embodiments, the contact management and sharing module 139 can include code to provide a “Share Public” option 426 shown in the display 130C (in dashed-lines). The “Share Public” option 426 can be used to manually initiate sharing of only the set of formal contact information of any shared contact to the second user 415.

FIG. 4B depicts an example of a set of contact information 260 associated with the contact identifier 210 presented within a display 130 of the first electronic device 100, according to one or more embodiments. In normal operations, when the share option 425 is activated, the contact information 260 is shared as-is with the second user 415. However, according to the described aspects of the disclosure, when the contact information 260 includes a differentiation/demarcation among the set of formal contact information 265 and the set of informal contact information 270, the program code for the contact management and sharing module 139 configures the electronic device 100 to selectively share only the set of formal contact information 265 in certain scenarios. As an example, referring to the dashed-line display UI 130B of FIG. 4A, when the contact is being shared with a second user 415, who is not in a safe list of people for receiving the contact details of a contact, or is an unknown person, or is not someone that the user 310 is comfortable sharing the set of informal contact information 270 with, the user 310 may want to keep the set of informal contact information 270 private and share only the set of formal contact information 265.

FIG. 4C depicts example set of contact details that is transmitted during the sharing of the contact with the second electronic device 407 in FIG. 4A, based on a status of the user/identifier associated with the second electronic device 407, according to one or more embodiments. The contact management and sharing module 139 can include code to enable the processor 102 to determine whether the second user 415 is someone that the set of informal contact information can be shared with. This can include determining whether the second user 415 is a member of a safe or trusted group 416, as depicted in FIG. 4A, of which the members include only those with whom the user 100 is comfortable sharing both the sets of formal and informal contact information with. When it is determined that the second user 415 is a member of the trusted group 416, one or both of the set of formal contact information 465 and the set of informal contact information 470 can be shared with the second user 415.

In one or more embodiments, the contact management and sharing module 139 may include code to enable the processor 102 to share only the set of formal contact information 265 when it is determined that the second user 415 is not a member of the trusted group 416. This may include sharing the formal contact identifier 430 and an updated contact icon 440 which may be more formal than the original contact icon 435, as depicted in FIG. 4A. Additionally, with this default setting of the contact sharing device feature, the GUI may be configured with a different share button, providing the user with the option of overriding the default and sharing all of the sets of contact details with a specific second user identifier that may not be included in the “safe” or “trusted” list.

FIGS. 4D-4E depict a sharing environment where a set of contact information, including personal contact details, of a contact associated with the first electronic device 100 is selectively obscured when shared as a screen shot with the second electronic device 407, according to one or more embodiments. The contact management and sharing module 139 can include code to enable the processor 102 to provide a user an option to share a screen shot of the contact details of a contact with another electronic device. In one or more embodiments, the share option 425 (depicted in FIG. 4A) may also be used to share a screen shot. Referring to FIG. 4D, an example of a screen shot of contact information that includes both formal contact information and informal contact information is shown within the display 130 of the first electronic device 100. The screen shot 460 may have been generated previously and stored in the memory 120. Alternatively, the screen shot 460 may be generated as part of the sharing operations. The screen shot 460 is depicted to include contact details 495 which include a contact identifier 210, and a contact icon 435. Since the screen shot 460 includes informal contact information, the user 310 may prefer not to share the screen shot 460 in its entirety.

In one or more embodiments, the contact management and sharing module 139 can include code to enable the processor 102 to determine whether the contact information in the screen shot 460 includes a set of informal contact information (FIG. 4B). The contact management and sharing module 139 can include code to enable the processor 102 to determine whether the second user 415 is a member of the trusted group 416. Based on identifying that the screen shot 460 includes a set of informal contact information and that the second user 415 is a member of the trusted group 416, the screen shot 460 can be shared with little or no modification with the electronic device 407 associated with the user 415.

Referring to FIG. 4E, an example of a screen shot that is received by the second electronic device 407 is shown within the display 455 without most of the information shown in FIG. 4D, according to one or more embodiments. Based on identifying that the screen shot 460 includes a set of informal contact information and that the second user 415 is not a member of the trusted group 416, the screen shot 460 may be updated before being shared with the electronic device 407. Updating the screen shot 460 may include identifying and blocking or obscuring or redacting (or otherwise making) any personal information included in the screen shot 460 from being viewable. As depicted in FIG. 4E, sections 485 and 490 of the screen shot 460 have been redacted, forming an updated screen shot 465. The updated screen shot 465 is presented within the display 455 of the electronic device 407 where any informal contact information included in the sections 485 and 490 is not viewable by the second user 415.

In one or more embodiments, updating the screen shot 460 may include updating the contact identifier 210 (also referred to as informal contact identifier), which is personal in context, to the contact identifier 418 (also referred to as formal contact identifier), which is more formal in context. Updating the screen shot 460 may also include changing the contact icon from contact icon 435, which is personal in nature, to the contact icon 440 which is more formal. In one or more embodiments, the contact management and sharing module 139 can include code to enable the processor 102 to, instead of obscuring or blocking, electronically removing the set of informal contact information included in the sections 485 and 490 from the screen shot 460 before the updated screen shot 460 is shared with the electronic device 407.

FIG. 4F depicts the automatic obscuring of specific portions of contact information, including personal contact details, when opening and/or presenting a contact on a display 130 of the electronic device 100 of the first user 310 while the first user 310 is in a public setting, according to one or more embodiments. A public setting is a setting where there are other people present, and where certain portions of personal contact information is obscured or blocked from being viewable when presented within the display 130. An example of a public setting is shown in group 492 which includes different form of transportation (bus, train, airplane) that the first user 310 can be using when the contact information is presented within the display 130.

In one or more embodiments, when the first user 310 views the contact details of a contact in a public setting, the contact management and sharing module 139 can include code to automatically detect that the first user 310 is in a public setting and cause only the information included in the set of formal contact information 265 to be presented within the display 130.

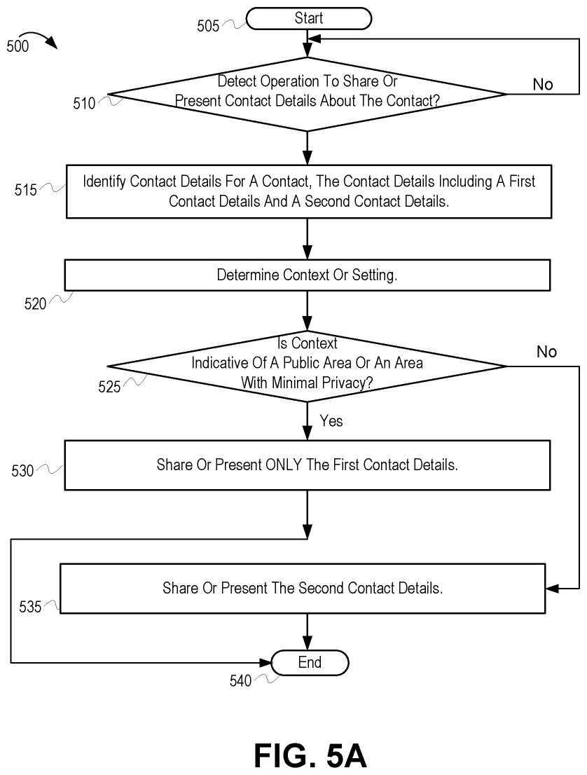

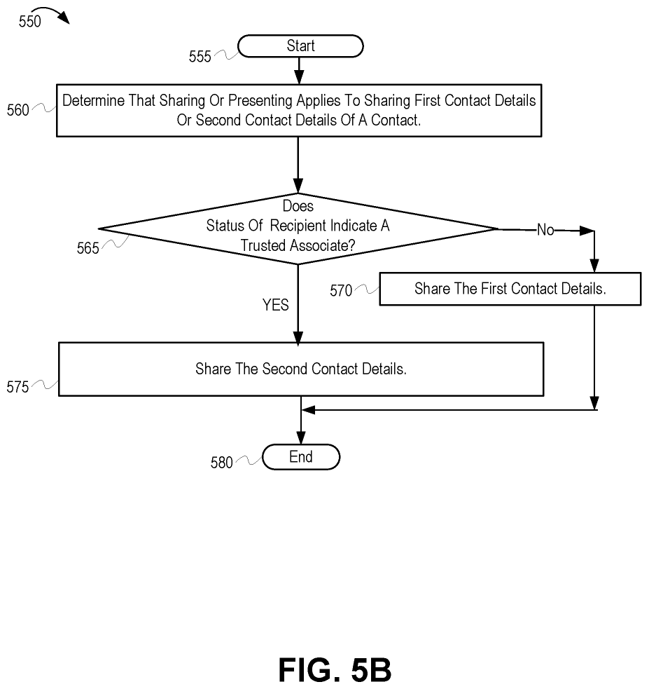

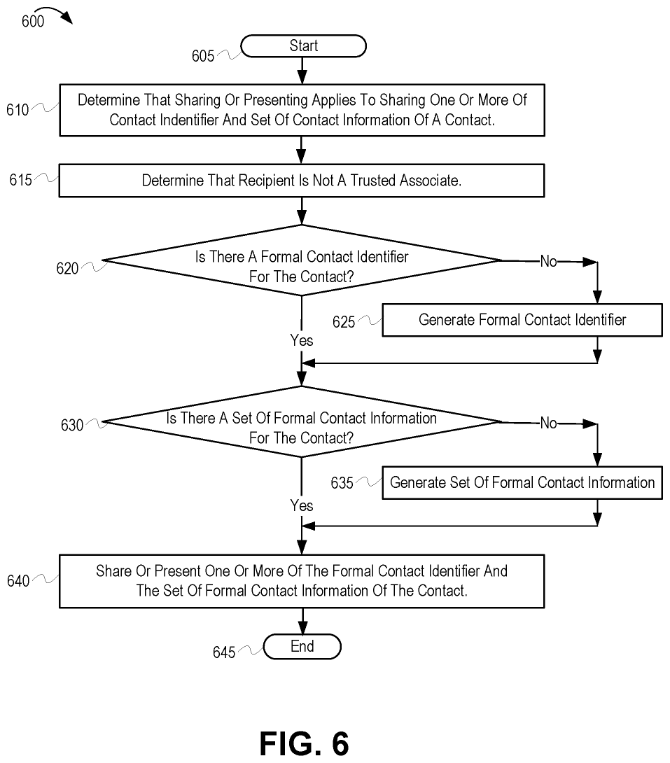

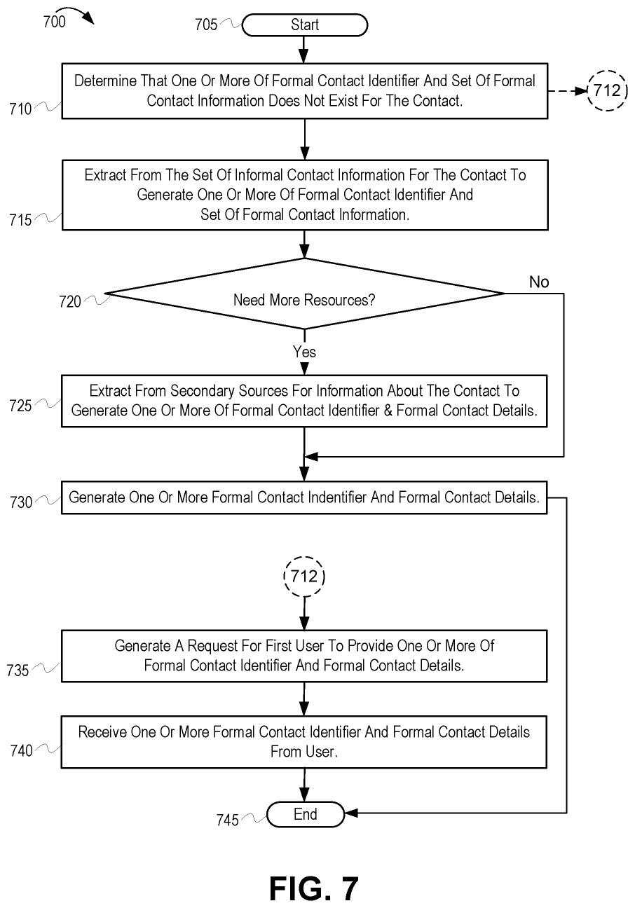

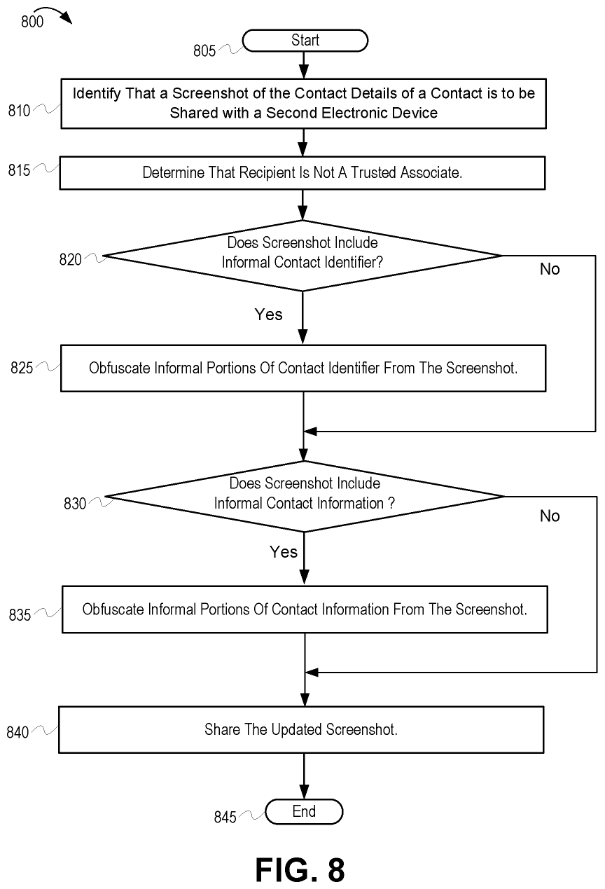

FIGS. 5A, 5B, and 6-8 depict flow diagrams of different methods for presenting or sharing contact details of a contact included in a contact directory associated with an electronic device, according to one or more embodiments. In at least one embodiment, electronic device 100 is controlled by processor 102, which executes code in the contact management and sharing module 139 (FIG. 1) to facilitate presenting or sharing contact details of a contact that includes functionality described for method 500 (FIG. 5A), as well as method 550 (FIG. 5B), method 600 (FIG. 6), method 700 (FIG. 7), and method 800 (FIG. 8).

The description of methods 500/550/600/700/800 is provided with general reference to the specific components illustrated within the preceding FIGS. 1-4, and specific components referenced in methods 500/600/700/800 may be identical or similar to components of the same name used in describing preceding FIGS. 1-4.

Method 500 of FIG. 5A depicts a process of sharing or presenting first contact details or second contact details based on detecting an operation to share or to present and based on a context or settings associated with the operation to share or present, in one or more embodiments. The method 500 can be applied to an electronic device 100 controlled by the processor 102 to present contact details of a contact included in a contact directory. The method 500 starts at block 505. In one or more embodiments, method 500 includes the processor 102 determining whether there is an operation to share or present the contact details for a contact (block 510). The operation to share or present the contact details may be triggered by an in-coming call received by the electronic device 100. The in-coming call may be initiated by another electronic device of a user whose contact details are stored in the contact directory 141. If there is no trigger, the method 500 stays at block 510 until a trigger is recognized.

From block 510, when there is a trigger, the method 500 identifies the contact details for a contact (block 515). The contact details include first contact details and second contact details. The first contact details can be publicly presentable or shareable. The second contact details are presentable or shareable in limited contexts or settings. For one or more embodiments, each of the first contact details and the second contact details includes a contact identifier. The first contact details and the second contact details for the contact are stored in a contact directory of the electronic device 100.

From block 515, the method 500 continues to block 520 where the processor 102 performs operations to determine a context or a setting which may affect how the contact details can be shared or presented.

At block 525, the context or setting determined at block 520 may be evaluated to determine whether the context or setting is indicative of an environment that is public or an environment that has minimal privacy. When the context or setting is indicative of an environment that is public or an environment that has minimal privacy, the first contact details may be presented or shared (block 530). In one or more embodiments, the operations in block 530 may include presenting a contact identifier associated with the first contact details (also referred to as formal contact identifier). After completion of the operations in block 530, the method 500 may end at block 540. From block 525, when the context or setting is indicative of an environment that is not public or an environment where there is sufficient privacy, the sharing or presenting of the second contact details may occur (block 535). In one or more embodiments, the operations in block 535 may include presenting a contact identifier associated with the second contact details (also referred to as an informal contact identifier). The informal contact identifier provides more personalized information than the formal contact identifier. It is appreciated that the first contact details may also be shared at block 535, such that a complete contact is shared, rather than a partial contact. After completion of the operations in block 535, the method 500 may end at block 540.

With reference to FIG. 5B, method 550 may be applied to an electronic device 100 controlled by processor 102 to execute code to determine a status of a user for the purpose of sharing contact details of a contact, in one or more embodiments. The method 550 may start at block 555. The processor 102 may execute code included in the contact management and sharing module 139 to enable the electronic device 100 to receive a request to share contact details of a contact with a second electronic device 407. The request to share may be triggered by activating a share option 425 (FIG. 4B). The sharing of contact details of a contact includes sharing first contact details and/or sharing second contact details (block 560). At block 565, the method 550 includes operations to determine a status of the user 417 (the recipient) of the second electronic device 407 as a trusted associate. The user 417 can be considered a trusted associate when the user 417 is a member of a defined group of trusted associates. For example, an immediate family member can be a trusted associate. When the user 417 is not a trusted associate, the method 550 continues to share the second contact details (or informal contact details) (block 575). In one or more embodiments, both the second contact details (or informal contact details) and the first contact details (or formal contact details) are shared. From decision block 565, when the user 417 is not a trusted associate, the method 550 continues to share the first contact details (or formal contact details) (block 570). The method 550 ends at block 580.

With reference to FIG. 6, method 600 may be applied to an electronic device 100 controlled by processor 102 to generate formal contact identifier and a set of formal contact information to be shared or presented by the electronic device 100 when the recipient is not a trusted associate, in one or more embodiments.

The method 600 may start at block 605. The processor 102 may execute code included in the contact management and sharing module 139 to enable the electronic device 100 to share contact details of a contact with a second electronic device 407. At block 610, the method 600 includes determining that the sharing and presenting of the contact details include sharing the contact identifier and set of contact information of a contact with the second electronic device. As discussed above, in one or more embodiments, as depicted in FIG. 3D, the first electronic device 100 presents contact information of a contact on the display 130 to be viewable by the first user 310, while, in one or more other embodiments, as depicted in FIG. 4A, the electronic device 100 shares or communicates the contact information of a contact with a second electronic device 407. The operations in block 610 therefore determines that the sharing operations are occurring, similar to the example depicted in FIG. 4A.

At block 615, the method 600 includes determining that the sharing or presenting is related to a recipient who is not identified as a trusted associate. As a result, only formal contact identifier and a set of formal contact information may be shared. Identifying the recipient as someone who is not a trusted associate may include verifying whether the recipient is a member of a group of trusted associates. In one or more embodiments, the contact details of a contact may include only an informal contact identifier and a set of informal contact information. As such, it may be necessary to verify whether the formal contact identifier exists for the contact (block 620) and whether the set of formal contact information exist for the contact (block 630). The operations of blocks 620 and 630 may be performed by verifying the content of the contact directory 141.

From block 620, when a formal contact identifier cannot be found, the formal contact identifier may be generated (block 625) using the informal contact identifier or the set of informal contact information. Similarly, from block 630, when the set of formal contact information cannot be found, a new set of formal contact information may be generated (block 635) using the set of informal contact information. In one or more embodiments, this generation of the set of formal contact information may be completed by implementing one or more different processes from among: (i) selecting a specific set of contact details, such as phone number and business name as the set of formal contact information; (ii) separating out certain personal information from the contact, such as a personal email, home phone number, birthday, etc. from the full set of contact details; and (iii) parsing other information, such as a text message or business website, or email communication, for information that is considered formal contact information. The latter process can also be implemented, using an AI engine, to parse these sources in order to find a formal contact identifier. The method 600 continues to block 640 where the formal contact identifier and the set of formal contact information of the contact may be shared with the second electronic device 407. The method 600 ends at block 645. The method 600 can be used to generate a formal contact identifier and a set of formal contact information when only an informal contact identifier and a set of informal contact information is included in the contact directory 141.

With reference to FIG. 7, method 700 may be applied to an electronic device 100 controlled by processor 102 to use information included in the contact directory 141 and secondary sources to generate the formal contact identifier and the set of formal contact information for a contact, in one or more embodiments. Method 700 starts at block 705 where it has been determined that, based on a context or setting, the formal contact identifier and the set of formal contact information are to be shared to the electronic device 407. At block 710, operations are performed to determine that the contact directory 141 does not include the formal contact identifier and the set of formal contact information. For one or more embodiments, the processor 102 executes code in the contact management and sharing module 139 to generate the formal contact identifier and the set of formal contact information by extracting information from the corresponding set of informal contact information (block 715). The operations associated with block 715 are almost similar to the operations described in FIG. 6. However, the information included in the informal contact information may not be sufficient to generate the formal contact identifier and/or the set of formal contact information.

The method 700 continues to block 720 to determine whether there is sufficient information in the set of informal contact information to generate one or more of the formal contact identifier and the set of formal contact information and whether more resources are necessary. When no additional recourses are necessary, the method 700 continues to block 730 where one or more of the formal contact identifier and the set of formal contact information are generated using only the informal contact information. From the block 720, when more resources are necessary, the method 700 continues to block 725 where secondary sources of information may be used to extract information to generate one or more of the formal contact identifier and the set of formal contact information. The secondary sources may include information identifying the contact and used during shared communication involving the contact. In one or more embodiments, the secondary sources can include one or more of a text message, a business website and email communication(s). From block 725, the method 700 continues to block 730 where one or more of the formal contact identifier and the set of formal contact information are generated using the information retrieved from the secondary sources and information from the set of informal contact details. The set of formal contact details can then be shared or presented. From block 730, the method 700 ends at block 745.

In one or more alternate embodiments, in addition to the operations to generate the formal contact identifier and the formal contact details, when sufficient information cannot be found from secondary sources, the method 700 can include operations to request that for the same information from the first user 310. In this scenario, from block 710, the method 700 can continue to block 735 by way of transition block 712. At block 735, the processor 102 executes code of the contact management and sharing module 139 to generate a request for the first user 310 of the electronic device 100 to provide one or more of the formal contact identifier and the set of formal contact information. For example, a pop-up widow may be presented on the display 130 of the electronic device 100, and the first user 310 can manually respond to the request. At block 740, the information provided by the first user 310 is received and can be used to set the one or more formal contact identifier and formal contact details. From block 740, the method 700 ends at block 745.

With reference to FIG. 8, method 800 may be applied to an electronic device 100 controlled by processor 102 to enable sharing a screenshot of contact details with a second electronic device 407 when the user of the second electronic device 407 is not a trusted associate, in one or more embodiments. Method 800 may start at block 805. At block 810, the processor 102 identifies that a screenshot of the contact details of a contact is to be shared with a second electronic device 407, as depicted in FIG. 4D. At block 815, the processor 102 determines that the user 415 associated with the second electronic device 407 is not a trusted associate. As a result, any informal contact information may not be shared with the user 415.

At block 820, the processor 102 determines whether the screen shot of the contact details includes an informal contact identifier of the contact that the user 100 may not want to share with the second user 415. When the screen shot of the contact details includes the informal contact identifier, the method 800 may continue to block 825 where the processor 102 obfuscates, blocks, or otherwise makes non-viewable the informal contact identifier from the screenshot. In one or more embodiments, only certain personal portions of the informal contact identifier are hidden. From block 820, when the screen shot of the contact details does not include the informal contact identifier or following the obfuscating process of block 825, the method 800 continues to block 830.

At block 830, the processor 102 determines whether the screenshot includes any informal contact information. From block 830, when the screen shot does not include any informal contact information, the method 800 continues to block 840. When the screen shot includes the informal contact information, the method 800 continues to block 835 where operations may be performed by the processor 102 to obfuscate, block, or otherwise makes non-viewable the informal portions of the contact information from the screenshot. The method 800 continues to block 840 where the remaining updated screen shot (i.e., the updated screen shot with informal content obfuscated or removed) is shared with the electronic device 417. The method 800 ends at block 845.

In one or more embodiments, one or more of methods 500/550/600/700/800 further include the first contact details having a first set of contact information and the second contact details having a second set of contact information. The first set of contact information is selectively linked with the first identifier. The second set of contact information is selectively linked with the second identifier. When the first contact details are determined to not be stored within a field of the first contact, the first identifier is generated using one or more of (i) additional information included in the first contact details and (ii) a secondary source that includes information identifying the first contact and used during shared communication involving the first contact. One or more of methods 500/550/600/700/800 further include having a display coupled to the at least one processor, wherein the at least one processor selectively presents the first contact details by displaying only the first contact details within the display in response to selecting the first contact for presenting on the display during a first type of context in which second contact details are not displayed. One or more of methods 500/550/600/700/800 further include the second contact details having personal attributes and profile data, and to selectively share or present only the first contact details, the at least one processor (i) identifies the personal attributes and profile data in the second contact details as data not to be shared with users not included in a list of safe associates, and (ii) based on the first contact details not being stored within a field of the first contact, shares or presents the second contact details as the first contact details without sharing or presenting the personal attributes and profile data.

Aspects of the present innovation are described above with reference to flowchart illustrations and/or block diagrams of methods, apparatus (systems) and computer program products according to embodiments of the innovation. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

As will be appreciated by one skilled in the art, embodiments of the present innovation may be embodied as a system, device, and/or method. Accordingly, embodiments of the present innovation may take the form of an entirely hardware embodiment or an embodiment combining software and hardware embodiments that may all generally be referred to herein as a “circuit,” “module” or “system.”

While the innovation has been described with reference to exemplary embodiments, it will be understood by those skilled in the art that various changes may be made, and equivalents may be substituted for elements thereof without departing from the scope of the innovation. In addition, many modifications may be made to adapt a particular system, device, or component thereof to the teachings of the innovation without departing from the essential scope thereof. Therefore, it is intended that the innovation not be limited to the particular embodiments disclosed for carrying out this innovation, but that the innovation will include all embodiments falling within the scope of the appended claims. Moreover, the use of the terms first, second, etc. do not denote any order or importance, but rather the terms first, second, etc. are used to distinguish one element from another.

The terminology used herein is for the purpose of describing particular embodiments only and is not intended to be limiting of the innovation. As used herein, the singular forms “a”, “an” and “the” are intended to include the plural forms as well, unless the context clearly indicates otherwise. It will be further understood that the terms “comprise” and/or “comprising.” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present innovation has been presented for purposes of illustration and description but is not intended to be exhaustive or limited to the innovation in the form disclosed. Many modifications and variations will be apparent to those of ordinary skill in the art without departing from the scope and spirit of the innovation. The embodiments were chosen and described in order to best explain the principles of the innovation and the practical application, and to enable others of ordinary skill in the art to understand the innovation for various embodiments with various modifications as are suited to the particular use contemplated.

What is claimed is:

1. An electronic device comprising:
a memory having stored thereon a contact management and sharing module for managing contact sharing;
at least one processor communicatively coupled to the contact management and sharing module, the at least one processor executing code of the contact management and sharing module, which configures the processor to:
identify, for a first contact maintained within a contact directory utilized by the electronic device, first contact details that is publicly sharable;
identify, for the first contact, second contact details that comprises information that is contextually limited from being publicly shared or presented; and
in response to detecting an operation to share or present the first contact, selectively share or present only the first contact details and withhold sharing or presenting of the second contact details.

2. The electronic device of claim 1, wherein:
the first contact details comprise at least a first identifier of the first contact; and
the second contact details comprise at least a second identifier that provides more personalized information than the first identifier and which is limited to being shared only with identified trusted recipients;
in response to sharing or presenting the first contact to a third party that is not identified as a trusted recipient, the processor restricts sharing of the first contact to only the first contact details; and
in response to sharing or presenting the first contact to a third party that is identified as a trusted recipient, the processor provides content from both the first contact details and the second contact details as a single shared contact to the third party.

3. The electronic device of claim 2, wherein:
the first contact details further comprises a first set of contact information selectively linked with the first identifier; and
the second contact details further comprises a second set of contact information selectively linked with the second identifier.

4. The electronic device of claim 3, wherein to identify the first contact details, the processor:
determines whether the first identifier is stored within a field of the first contact; and
in response to the first identifier not being stored within a field of the first contact, generates the first identifier using one or more of (i) additional information included in the first contact details and (ii) a secondary source that includes information identifying the first contact and used during shared communication involving the first contact.

5. The electronic device of claim 3, further comprising:
a display coupled to the at least one processor, wherein the at least one processor selectively presents the first contact details by displaying only the first contact details within the display in response to selecting the first contact for presenting on the display during a first type of context in which second contact details are not displayed.

6. The electronic device of claim 1, wherein the second contact details are restricted from being presented on a display of the electronic device while the electronic device is determined to be in a public environment.

7. The electronic device of claim 1, wherein to selectively share or present only the first contact details, the processor is further configured to:
determine a context in which the operation to share or present the first contact is being completed; and
in response to determining that the context is a first type of context in which a restriction exists on sharing or presenting the second contact details, trigger the selectively sharing or presenting of only the first contact details.

8. The electronic device of claim 1, further comprising:
a communication interface by which the electronic device communicatively connects to at least one second device, the communication interface communicatively coupled to the processor; and
wherein the processor selectively shares only the first contact details, in response to detecting the operation to share the first contact with the at least one second device.

9. The electronic device of claim 8, wherein to selectively share only the first contact details, the processor:
determines an identification of a second user of the at least one second device;
compares the identification of the second user with a list of safe associates;
in response to the second user being included within the list of safe associates, shares one or more of the second identifier and the second set of contact information to the second device; and
shares the first contact details to the second device, in response to the second user not being included in the list of safe associates.

10. The electronic device of claim 1, wherein the second contact details includes personal attributes and profile data, and to selectively share or present only the first contact details, the processor:
identifies the personal attributes and profile data in the second contact details as data not to be shared with users not included in a list of safe associates;
based on the first contact details not being stored within a field of the first contact, shares or presents the second contact details as the first contact details without sharing or presenting the personal attributes and profile data.

11. A method comprising:
identifying, for a first contact maintained within a contact directory utilized by an electronic device, first contact details that is publicly sharable;
identifying, for the first contact, second contact details that comprises information that is contextually limited from being publicly shared or presented; and
in response to detecting an operation to share or present the first contact, selectively sharing or presenting only the first contact details and withhold sharing or presenting of the second contact details.

12. The method of claim 11, wherein:
the first contact details comprise at least a first identifier of the first contact;
the second contact details comprise at least a second identifier that provides more personalized information than the first identifier and which is limited to being shared only with identified trusted recipients;
in response to sharing or presenting the first contact to a third party that is not identified as a trusted recipient, restricting sharing of the first contact to only the first contact details; and
in response to sharing or presenting the first contact to a third party that is identified as a trusted recipient, providing content from both the first contact details and the second contact details as a single shared contact to the third party.

13. The method of claim 12, wherein:
the first contact details further comprises a first set of contact information selectively linked with the first identifier; and
the second contact details further comprises a second set of contact information selectively linked with the second identifier.

14. The method of claim 13, wherein identifying the first contact details comprises:
determining whether the first identifier is stored within a field of the first contact; and
in response to the first identifier not being stored within a field of the first contact, generating the first identifier using one or more of (i) additional information included in the first contact details and (ii) a secondary source that includes information identifying the first contact and used during shared communication involving the first contact.

15. The method of claim 13, further comprising:
displaying only the first contact details within a display in response to selecting the first contact for presenting on the display during a first type of context in which second contact details are not displayed.

16. The method of claim 11, wherein the second contact details are restricted from being presented on a display of an electronic device while the electronic device is determined to be in a public environment.

17. The method of claim 11, wherein selectively sharing or presenting only the first contact details comprises:
determining a context in which the operation to share or present the first contact is being completed; and
in response to determining that the context is a first type of context in which a restriction exists on sharing or presenting the second contact details, triggering the selectively sharing or presenting of only the first contact details.

18. The method of claim 11, wherein the electronic device is communicatively connected to at least one second device associated with a second user, the method further comprising:
in response to the second user being included within a list of safe associates, sharing one or more of the second identifier and the second set of contact information to the at least one second device; and
sharing the first contact details to the at least one second device, in response to the second user not being included in the list of safe associates.

19. A computer program product comprising:
a computer readable storage device; and
program code on the computer readable storage device that when executed by a processor associated with a communication device, the program code enables the communication device to provide functionality of:
identifying, for a first contact maintained within a contact directory utilized by an electronic device, first contact details that is publicly sharable;
identifying, for the first contact, second contact details that comprises information that is contextually limited from being publicly shared or presented; and
in response to detecting an operation to share or present the first contact, selectively sharing or presenting only the first contact details and withhold sharing or presenting of the second contact details.

20. The computer program product of claim 19, wherein:
the first contact details comprise at least a first identifier of the first contact;
the second contact details comprise at least a second identifier that provides more personalized information than the first identifier and which is limited to being shared only with identified trusted recipients;
in response to sharing or presenting the first contact to a third party that is not identified as a trusted recipient, restricting sharing of the first contact to only the first contact details; and
in response to sharing or presenting the first contact to a third party that is identified as a trusted recipient, providing content from both the first contact details and the second contact details as a single shared contact to the third party.
